(19) United States
(12) Patent Application Publication
(10) Pub. No.: US 2022/0324541 A1
(43) Pub. Date: Oct. 13, 2022

(54) STRUCTURE FOR OFFSHORE PLANT

(71) Applicant: JGC CORPORATION, Kanagawa (JP)

(72) Inventors: Tadafumi KANAYAMA, Kanagawa (JP); Keiji TANIGAWA, Kanagawa (JP)

(73) Assignee: JGC CORPORATION, Kanagawa (JP)

(21) Appl. No.: 17/641,819

(22) PCT Filed: Nov. 28, 2019
(86) PCT No.: PCT/JP2019/046598

§ 371 Date: Mar. 10, 2022

(51) Int. Cl. B63B 35/44

(52) U.S. Cl. CPC B63B 35/44; B63B 2035/448

(57) ABSTRACT

A structure for an offshore plant has a plurality of module portions mounted on a structure body in which a storage tank for storing liquefied natural gas is installed. A pump opening serving as the inlet/outlet of a pump for pumping up the liquefied natural gas from the storage tank is formed in the structure body, and the pump opening is disposed between the module portions adjacent to each other.

### TECHNICAL FIELD

The present invention relates to a structure for an offshore plant for treating natural gas at sea.

### RELATED ART

Conventionally, a gravity based structure (GBS) and floating liquefied natural gas (FLNG) have been known as bases equipped with treatment facilities for treating natural gas (for example, see Patent Literature 1).

As shown in FIG. 9, a tank 106 having liquefied natural gas stored therein is housed inside this base, and a pump 108 for pumping up the liquefied natural gas is disposed inside the tank 106. Note that, in FIG. 9, an example in which a GBS 102 is used as a base of a structure 101 for an offshore plant has been shown.

When the pump 108 is maintained, the pump 108 is temporarily separated from a pipe 110, and only the pump 108 is taken out from the tank 106 through a pump opening 111. In this case, it is necessary to secure, above the pump opening 111, a height space A for performing the work of taking out the pump 108.

### CITATION LIST

### Patent Literature

Patent Literature 1: Publication No. NO20190944

### SUMMARY OF INVENTION

### Technical Problem to Be Solved

However, in addition to an equipment module 112, various structures such as pipe racks and the like (not shown) are densely packed on the GBS 102. The same applies to a FLNG hull. Therefore, in order to secure the height space A above the pump opening 111, an underfloor height B from an upper end surface 104a of a structure body 104 to a underfloor surface 112a of the lowermost stage of the equipment module 112, and an under-horizontal frame height (not shown) from the upper end surface 104a of the structure body 104 to a lower end surface of the lowermost horizontal frame of the pipe rack are required to be set to a predetermined height or more, for example, 7 to 8 m or more, or the like.

In this way, when the underfloor height B of the lowermost stage of the equipment module 112 or the under-horizontal frame height of the lowermost stage of the pipe rack is set to a predetermined height or more, a top end height of the equipment module 112, the pipe rack, or the like is high, and the center of gravity of the structure 101 for an offshore plant is high. Therefore, it is necessary to have a sturdy design for purposes such as increasing the strength of the module or a support structure of the equipment, and thus there is a problem that the construction cost increases.

An objective of the present invention is to provide a structure for an offshore plant capable of reducing the height of a module and securing a maintenance space for a pump to be taken in and out of a tank.

### Solution to Problem

A structure for an offshore plant of the present invention has a plurality of module portions mounted on a structure body in which a storage tank for storing liquefied natural gas is installed,

a pump opening serving as an inlet/outlet of a pump for pumping up the liquefied natural gas from the storage tank is formed in the structure body, and
the pump opening is disposed between the module portions adjacent to each other.

According to this configuration, because the module portion is disposed avoiding the pump opening, the upper part of the pump opening is open. Thereby, a take-out height of the pump can be sufficiently secured above the pump opening. In addition, it is not necessary to secure the take-out height of the pump below the module portion, and thus it is not necessary to design a high module portion in consideration of the take-out height, and a height of the lowermost stage of the module portion can be lowered. As described above, according to this configuration, the height of the module portion can be reduced, and thus the construction cost of the module portion can be suppressed.

In addition, in the structure for an offshore plant of the present invention, the module portions include equipment module portions on which equipment is mounted and pipe module portions on which pipes are mounted.

That is, the equipment module portion and the pipe module portion are mainly used in the plant.

In addition, in the structure for an offshore plant of the present invention, the pump opening is disposed between the equipment module portions adjacent to each other. Thereby, the maintenance space of the pump can be sufficiently secured at a place where the equipment module portion is located.

In addition, in the structure for an offshore plant of the present invention, the pump opening is disposed between the equipment module portion and the pipe module portion adjacent to each other.

Thereby, the maintenance space of the pump can also be sufficiently secured when the pipe module portion is adjacent to the equipment module portion.

In addition, the structure for an offshore plant of the present invention includes a pipe for connecting the module portions, and

the pipe is disposed outside a draw-out area which is formed above the pump opening and used for drawing out the pump.
Thereby, even if the pipe for connecting the module portions adjacent to each other is installed, it does not get in the way when the pump is drawn out from the pump opening, and the maintenance space of the pump can be sufficiently secured.

In addition, a structure for an offshore plant of the present invention has a plurality of module portions mounted on a structure body in which a storage tank for storing liquefied natural gas is installed,

a pump opening serving as an inlet/outlet of a pump for pumping up the liquefied natural gas from the storage tank is formed in the structure body,
an upper end portion of the pump opening is located lower than an upper end surface of the structure body,
and the pump opening is located directly below the module portion.

Thereby, because the pump can be drawn out from below the upper end surface of the structure body, a part of a draw-out height of the pump can be secured below the upper end surface of the structure body. Specifically, the draw-out height of the pump to be secured above the upper end surface of the structure body can be lowered by a height corresponding to a distance (height) between the upper end portion of the pump opening and the upper end surface of the structure body. Therefore, the height of the lowermost stage of the module portion can be lowered, and the height of the module portion can be reduced.

In addition, in the structure for an offshore plant of the present invention,

the pump opening is formed in a recess formed by making the upper end surface recessed in the structure body.
In this way, by forming a recess on the upper end surface of the structure body, the maintenance space of the pump can be sufficiently secured.

In addition, in the structure for an offshore plant of the present invention, a gravity based structure (GB S) or floating liquefied natural gas (FLNG) is used as a base portion. That is, the present invention is intended for a structure in which a plant is mounted on an offshore base portion such as a GBS, FLNG, or the like.

### Effects of Invention

According to the present invention, it is possible to provide a structure for an offshore plant capable of reducing the height of a module and securing a maintenance space for a pump for pumping up liquefied natural gas.

### BRIEF DESCRIPTION OF DRAWINGS

FIG. 1 is a schematic view of a structure for an offshore plant according to a first embodiment as viewed from the lateral side.

FIG. 2 is a schematic view of the structure for an offshore plant according to the first embodiment as viewed from above.

FIG. 3 is a schematic diagram showing a case in which liquefied natural gas is supplied to a tank from the structure for an offshore plant according to the first embodiment.

FIG. 4 is a schematic view of a structure for an offshore plant according to a modified aspect of the first embodiment as viewed from the lateral side.

FIG. 5 is a schematic view of a conventional structure for an offshore plant as viewed from the lateral side.

FIG. 6 is a schematic view of a structure for an offshore plant according to a second embodiment as viewed from the lateral side.

FIG. 7 is a schematic diagram showing a process of mounting a module on a GBS according to the second embodiment.

FIG. 8 is a schematic view of the structure for an offshore plant according to a modified aspect of the first embodiment as viewed from above.

FIG. 9 is a schematic view of the conventional structure for an offshore plant as viewed from the lateral side.

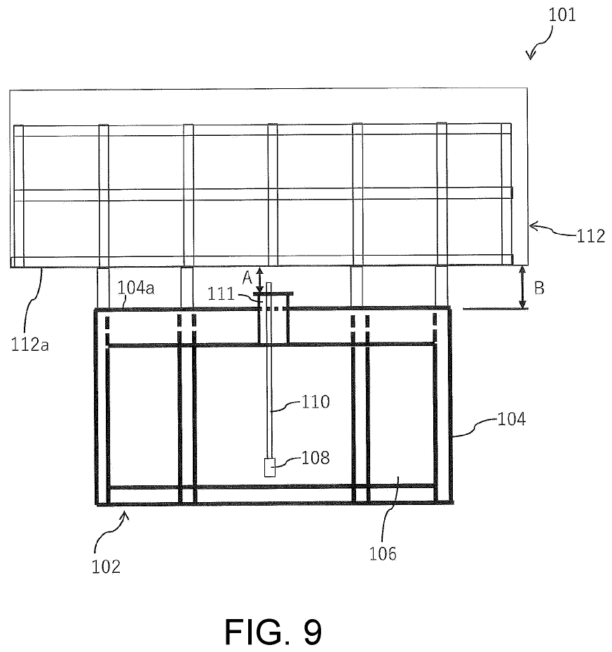

### DESCRIPTION OF EMBODIMENTS

Hereinafter, with reference to the drawings, a structure for an offshore plant according to a first embodiment of the present invention is described by taking a case in which a GBS is used for a base portion as an example. Here, the GBS is a structure for mounting large-scale facilities such as an offshore wind power facility, various gas treatment facilities, a natural gas receiving facility, and the like, and is landed on the seabed and deployed offshore. In the first embodiment, a case in which a natural gas treatment facility is mounted on the GBS is described.

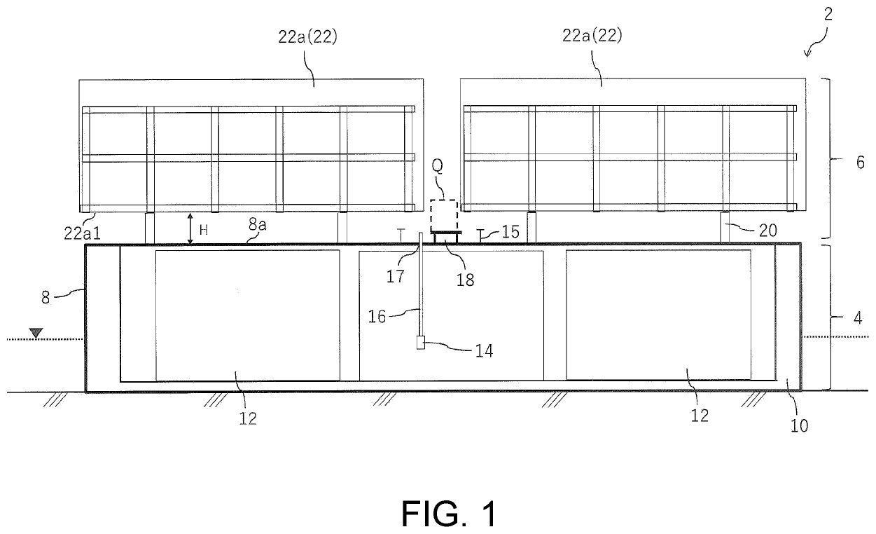

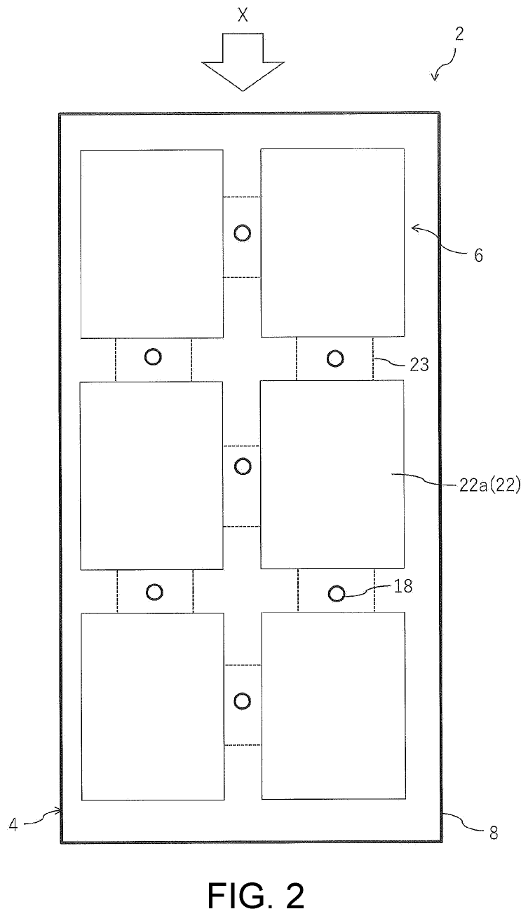

FIG. 1 is a schematic view of the structure for an offshore plant according to the first embodiment as viewed from the lateral side, and FIG. 2 is a schematic view of the structure for an offshore plant as viewed from above. Note that, FIG. 1 shows an elevation surface viewed from an X arrow direction shown in FIG. 2. As shown in FIGS. 1 and 2, a structure 2 for an offshore plant includes a base portion 4 that lands on the seabed and a module 6 installed on the base portion 4.

Here, the base portion 4 has a substantially rectangular parallelepiped shape, and includes a structure body 8 constituting the outer frame of the base portion 4. Besides, inside the structure body 8, a ballast tank 10 that is a space in which water, sand, or the like is injected as a weight for landing the base portion 4, and a storage tank 12 for storing liquefied natural gas are arranged.

In the embodiment, the storage tank 12 is disposed from one end to the other end in a longitudinal direction of the base portion 4. Besides, a plurality of storage tanks 12 are disposed side by side in a lateral direction of the base portion 4. Moreover, the storage tank 12 may have an elongated shape extending from one end to the other end in the longitudinal direction, and one storage tank 12 is arranged in the longitudinal direction. In addition, a plurality of storage tanks 12 may be disposed side by side in the longitudinal direction.

Inside the storage tank 12, a pump 14 for pumping up liquefied natural gas and a pipe 16 serving as a passage for the liquefied natural gas pumped up by the pump 14 are disposed. Besides, on an upper surface of the structure body 8, a tank dome 15 having a through hole 17 for the pipe 16 and a pump opening 18 is arranged. The pump opening 18 is an opening used as a passage for the pump 14 to be taken in and out during maintenance and the like. Above the pump opening 18, there is a draw-out area Q used for drawing out the pump 14 in the storage tank 12. In addition, the tank dome 15 is a frame-shaped member that surrounds openings communicating with the inside of the storage tank 12, such as the through hole 17, the pump opening 18, and the like, which are collectively arranged at predetermined locations on the storage tank 12.

The module 6 has a module portion 22 disposed on a column leg 20 called a stool on the structure body 8, and the pump opening 18 is disposed between the module portions 22 adjacent to each other. Hereinafter, the entire module including the column leg 20 is referred to as the module 6, and the main body of the module 6 excluding the column leg 20 is referred to as the module portion 22. Note that, in FIG. 1, an equipment module portion 22a is illustrated as the module portion 22. The equipment module portion 22a is a plant facility equipped with various equipment for liquefying natural gas and storing the liquefied natural gas in the storage tank 12. In addition, a pipe 23 connecting the module portions 22 is arranged between the module portions 22 adjacent to each other. In the embodiment, the pipe 23 connecting the installed equipment is arranged between the equipment module portions 22a adjacent to each other.

In the structure 2 for an offshore plant, the pump opening 18 is disposed between the equipment module portions 22a adjacent to each other. In addition, the pipe 23 connecting the equipment module portions 22a is disposed avoiding a range that interferes with the take-out of the pump 14. Specifically, the pipe 23 is disposed outside the draw-out area Q which is formed above the pump opening 18 and used for drawing out the pump 14. That is, the pipe 23 is disposed above the draw-out area Q or on the lateral side of the draw-out area Q. In this case, an underfloor height H from an upper end surface 8a of the structure body 8 to an underfloor surface 22a1 of the lowermost stage of the equipment module portion 22a is 1 m or more and 5 m or less. The underfloor height H is preferably about 1.5 m or more and 3 m or less, and it is sufficient that the underfloor height H is lower than the conventional underfloor height (for example, about 6 m to 7 m). Note that, the draw-out area Q is an area in which the pump 14 moves up and down when the pump 14 is drawn out and lowered, and is an area in which a large structure that hinders the vertical movement of the pump 14 is not installed.

Next, an example of the flow of treatment of natural gas is described. First, the natural gas, which is a raw material, is supplied from a gas field or an existing pipeline to the equipment module portion 22a on the base portion 4. Here, the equipment module portion 22a includes a pretreatment facility, a heavy component removal facility, and a liquefaction facility, none of which is shown. The pretreatment facility is a facility for executing a pre-step of liquefying the natural gas supplied from a wellhead, and a process from a separation step of separating a condensate contained in the natural gas, an acid gas removal step of removing acid gas, a mercury removal step of removing mercury, to a dehydration step of performing dehydration treatment is executed.

Here, in the separation step, the separated condensate is stored in a condensate tank (not shown) as needed. In the acid gas removal step, in an absorption tower (not shown), amine is brought into countercurrent contact with natural gas, and environmental pollutants such as carbon dioxide gas, hydrogen sulfide, and the like are absorbed by the amine and removed.

The mercury removal step is a step of removing mercury from natural gas when the natural gas contains a small amount of mercury vapor. Mercury corrodes aluminum alloys used as a low temperature member, and thus the mercury must be removed. In the dehydration step, water is removed by using an adsorbent from the natural gas from which impurities have been removed. The dehydration is performed to prevent ice from being generated in the subsequent liquefaction step and prevent pipes from being frozen.

In the heavy component removal facility, a heavy component removal step of removing heavy components from natural gas as needed is carried out. The heavy component removal facility is a part that separates the natural gas treated by the pretreatment facility into fractions such as methane, ethane, propane, and the like. In the heavy component removal facility, in addition to separating methane, heavy hydrocarbons such as ethane, propane, butane, and the like are separated and recovered.

The liquefaction facility is a facility for executing the step of liquefying natural gas, and in the liquefaction facility, a heat exchanger for liquefying methane, a refrigerant circuit for supplying a refrigerant to the heat exchanger, and the like are arranged.

In the liquefaction facility, a liquefaction step of liquefying natural gas is executed. In the liquefaction step, the natural gas sent to the heat exchanger is heat-exchanged with low temperature gas supplied from the refrigerant circuit, and cooled to −162° C. or lower to be liquefied. The liquefied low temperature natural gas is sent to the storage tank 12 via a pipe and then stored in the storage tank 12.

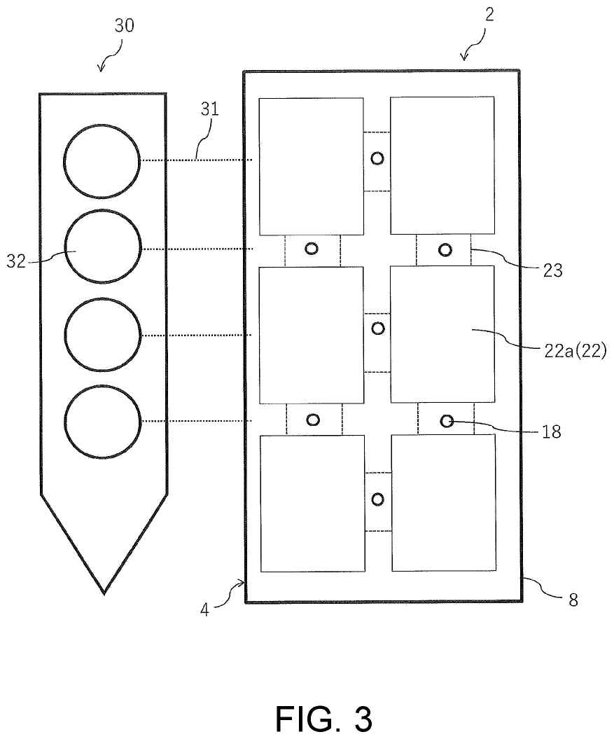

Here, as shown in FIG. 3, when a tanker 30 such as a LNG ship or the like calls at the structure 2 for an offshore plant, the liquefied natural gas stored in the storage tank 12 is pumped up by the pump 14, and then supplied to a tank 32 mounted on the tanker 30 via the pipe 16 and a loading arm 31. When the liquefied natural gas is stored in the tank 32, the tanker 30 sails to a receiving base. Thereafter, at the receiving base, the liquefied natural gas stored in the tank 32 is supplied to a treatment plant of the receiving base, returned to gas by the treatment plant, and then consumed as city gas.

According to the structure 2 for an offshore plant of the first embodiment, the pump opening 18 is disposed between the equipment module portions 22a adjacent to each other, and thereby when the pump 14 is maintained, the pump 14 can be taken out from the storage tank 12 without worrying about the floor height of the module portion 22, and the maintenance space of the pump 14 can be sufficiently secured. Furthermore, the pump opening 18 is disposed avoiding the pipe 23 connecting the equipment installed in the equipment module portion 22a, and thereby the maintenance space of the pump 14 can be secured more reliably.

In addition, by disposing the pump opening 18 in a manner that the module portion 22 (for example, the equipment module portion 22a) is not located directly above the pump opening 18, the module portion 22 can be designed without considering the draw-out height of the pump 14, and thus the top end height of the module portion 22 can be suppressed. Thereby, the strength required for the module portion 22 can be lowered, and the construction cost of the module portion 22 can be suppressed. Furthermore, because the top end height of the module portion 22 can be suppressed, the center of gravity of the structure 2 for an offshore plant can be lowered. Thereby, a stable and highly safe structure can be constructed. For example, it is not easily affected by changes in the ocean such as marine weather, wave conditions, and the like. Additionally, reinforcement for earthquakes can also be reduced.

Moreover, in the first embodiment described above, the module portion 22 is exemplified by the equipment module portion 22a in which the equipment constituting the pretreatment facility, the heavy component removal facility, or the liquefaction facility is installed. However, the present invention can also be applied when the module portion 22 is not the equipment module portion 22a.

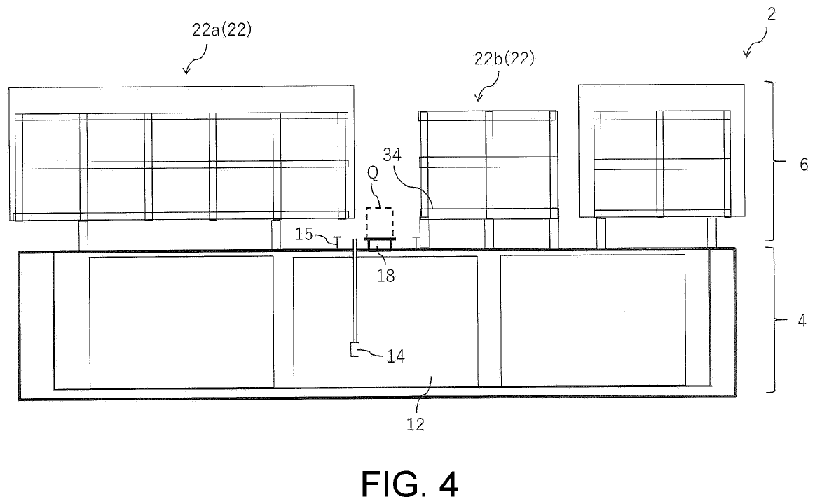

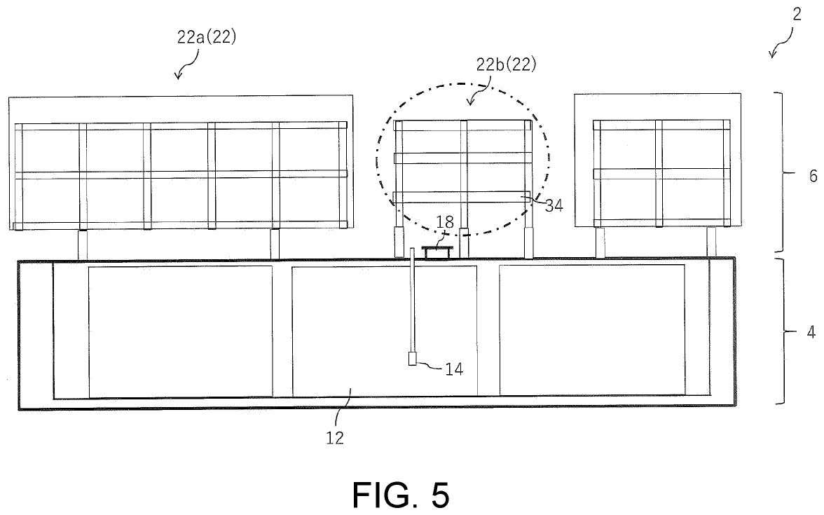

For example, as shown in FIG. 4, the same effect can be obtained even when the pump opening 18 is disposed between the equipment module portion 22a and a pipe module portion 22b such as a pipe rack or the like. Specifically, the pipe module portion 22b such as a pipe rack or the like is formed with a rigid structure. Therefore, when the pump opening 18 is arranged under the pipe module portion 22b, in order to secure the maintenance space, it is necessary to increase the height of the lowermost horizontal frame 34 as shown in FIG. 5. In this case, by disposing the pump opening 18 between the equipment module portion 22a and the pipe module portion 22b, the height of the lowermost horizontal frame 34 can be suppressed, and the center of gravity of the pipe module portion 22b can be lowered.

Furthermore, the module portion 22 may also include a residential area, a power generation facility, and the like (not shown) in addition to the equipment module portion 22a and the pipe module portion 22b.

Next, a structure for an offshore plant according to a second embodiment is described with reference to the drawings. The structure for an offshore plant according to the second embodiment is different from the first embodiment in that the pump opening 18 is disposed directly under the module portion 22. In the structure for an offshore plant according to the second embodiment, the structure body 8 of the base portion 4 is provided with a recess formed by making the upper end surface 8a recessed, and the pump opening 18 is disposed in the recess. Hereinafter, the description of the same configuration as that of the first embodiment is omitted, and only the different parts are described. In addition, the same configuration as that of the first embodiment is described with the same reference signs.

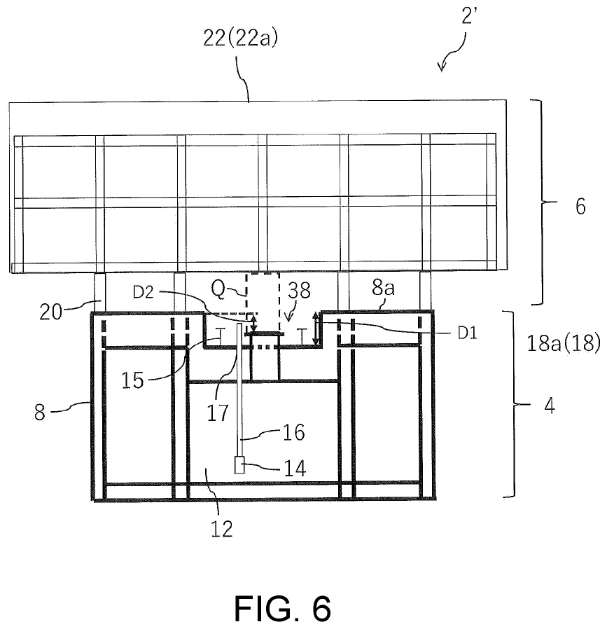

FIG. 6 is a schematic view of a structure 2′ for an offshore plant according to the second embodiment as viewed from the lateral side. As shown in FIG. 6, in the structure 2′ for an offshore plant, a recess 38 formed by making the upper end surface 8a recessed is formed in the central portion of the upper end surface 8a of the structure body 8. Besides, in the recess 38, the tank dome 15 having the through hole 17 for the pipe 16 and the pump opening 18 is arranged. Note that, a depth D1 of the recess 38 from the upper end surface 8a is about 0 m or more and 6 m or less, but the depth D1 is not limited thereto and may be formed deeper than 6 m. Moreover, the pump opening 18 may be disposed at a position close to the edge of the upper end surface 8a of the structure body 8 as long as the pump opening 18 is arranged in the upper part of the storage tank 12 and communicates with the storage tank 12.

In addition, on the upper end surface 8a of the structure body 8, the column leg 20 of the module portion 22 is disposed around the recess 38. Here, an upper end portion 18a of the pump opening 18 is located lower than the upper end surface 8a of the structure body 8. Specifically, a distance (height difference) D2 between the upper end portion 18a of the pump opening 18 and the upper end surface 8a of the structure body 8 may be 0 m or more and D1 or less. The larger the distance D2, the lower the height of the draw-out area Q to be secured above the upper end surface 8a of the structure body 8, and thus a larger distance D2 is preferable.

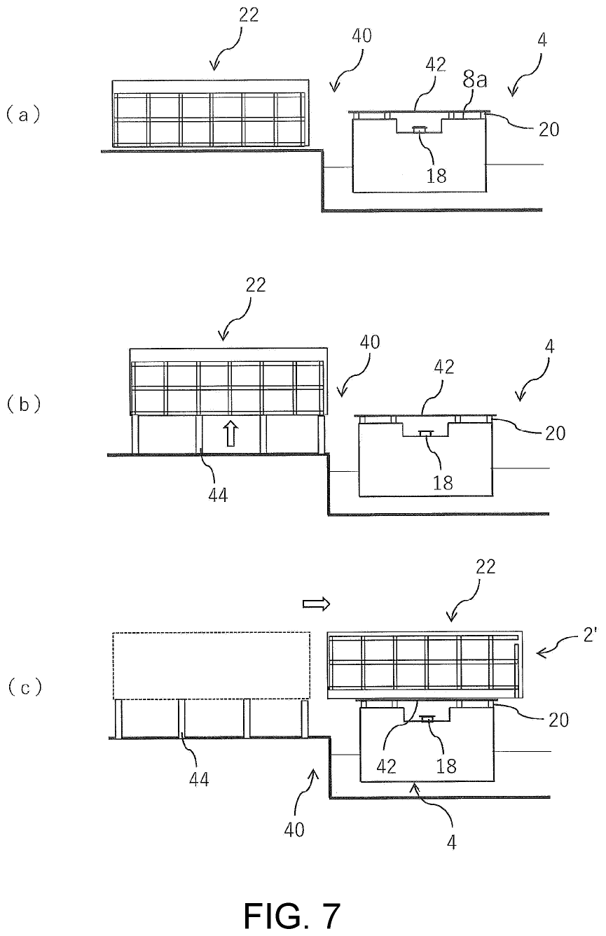

Next, a construction method called jack-up and skidding for placing the module portion 22 onto the base portion 4 according to the second embodiment is described. The construction method is also implemented in the first embodiment. First, as shown in (a) of FIG. 7, the base portion 4 is initially moored to a dock 40. The column leg 20 called a stool is disposed on the structure body 8 of the base portion 4 moored to the dock 40, and a rail 42 is disposed on the upper end surface 8a of the structure body 8 or on the column leg 20.

Here, when the module portion 22 is carried into the dock 40 and transferred to a lift 44, as shown in (b) of FIG. 7, the lift 44 rises to a height at the same level as the rail 42. Next, by moving the module portion 22 from the lift 44 to the rail 42, as shown in (c) of FIG. 7, the module portion 22 is installed on the base portion 4. Next, after the base portion 4 on which the module portion 22 is installed, that is, the structure 2′ for an offshore plant is towed to the destination by a towing ship, water, sand, or the like is injected into the ballast tank 10, and then the structure 2′ for an offshore plant is landed. Thereafter, the natural gas is supplied from a gas field or an existing pipeline to the equipment module portion 22a on the base portion 4, and the treatment described in the first embodiment is performed.

According to the structure 2′ for an offshore plant of the second embodiment, the recess 38 formed by making the upper end surface 8a recessed is formed in the central portion of the upper end surface 8a of the structure body 8, the upper end portion 18a of the pump opening 18 is located below the upper end surface 8a of the structure body 8, and thereby the height of the rail 42 can be suppressed. Therefore, the center of gravity of the structure 2′ for an offshore plant can be lowered, and for example, the safety in the event of an earthquake can be improved.

Moreover, in the second embodiment described above, the equipment module portion 22a is illustrated as the module portion 22, but the module portion 22 may also be the pipe module portion 22b, a residential area, a power generation facility, or the like.

In addition, by forming the recess 38 formed by making the upper end surface 8a recessed in the central portion of the upper end surface 8a of the structure body 8, the maintenance space of the pump 14 can be sufficiently secured.

In addition, in the second embodiment described above, the jack-up and skidding is performed at the dock 40 and then the structure 2′ for an offshore plant is towed offshore, but the jack-up and skidding may also be performed offshore.

Moreover, in each of the above embodiments, the case that the GBS is used for the base portion 4 on which the plant is mounted has been described as an example, but the base portion 4 is not necessarily limited to the GBS, and for example, the FLNG may also be used.

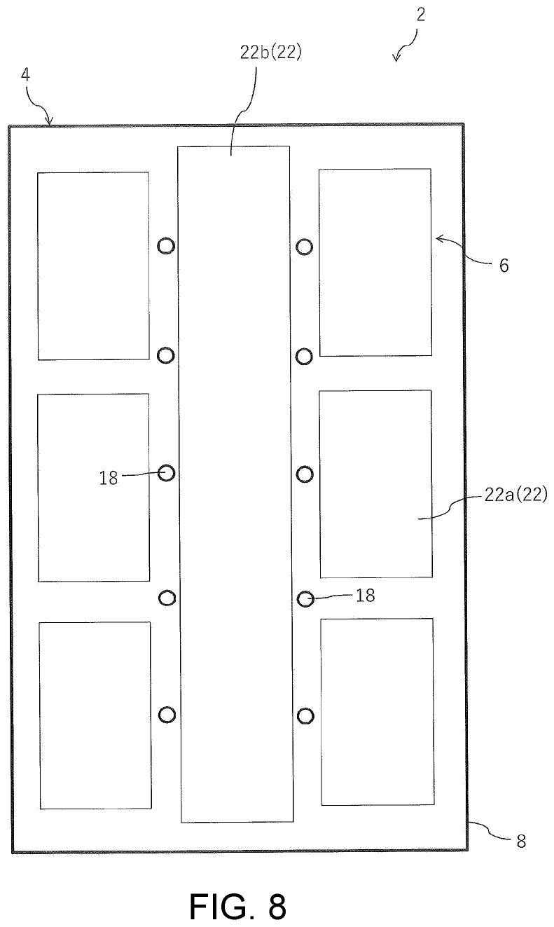

In addition, in FIG. 2, the case that one pump opening 18 is disposed between the equipment module portion 22a and the equipment module portion 22a has been shown, but a plurality of pump openings 18 may be disposed between the module portions 22. In addition, as shown in FIG. 8, as the arrangement of the module portion 22, the pipe module portion 22b may be disposed in the central portion of the base portion 4, and the equipment module portions 22a may be disposed on two sides of the pipe module portion 22b. In this case, the pump opening 18 may be disposed between the equipment module portion 22a and the pipe module portion 22b along the longitudinal direction of the base portion 4. Furthermore, the pump opening 18 may be disposed between the pipe module portions 22b adjacent to each other, and the number and arrangement of the pump opening 18 are not particularly limited.

In addition, the pipe 23 may be arranged between the equipment module portion 22a and the pipe module portion 22b adjacent to each other, or may be arranged between the pipe module portions 22b. That is, the pipe 23 may be disposed outside the draw-out area Q.

In addition, the equipment module portion 22a having equipment for treating natural gas before liquefaction installed thereon may be used as a high temperature module portion, the equipment module portion 22a having equipment for liquefying natural gas installed thereon may be used as a low temperature module portion, and the pump opening 18 may be disposed between the high temperature module portion and the low temperature module portion.

### REFERENCE SIGNS LIST

2, 2′ structure for an offshore plant
4 base portion
6 module
8 structure body
8a upper end surface of structure body
10 ballast tank
12 storage tank
14 pump
15 tank dome
16 pipe
17 through hole
18 pump opening
18a upper end portion of pump opening
20 column leg
22 module portion
22a equipment module portion
22a1 underfloor surface
22b pipe module portion
23 pipe
30 tanker
31 loading arm
32 tank
34 lowermost horizontal frame
38 recess
40 dock
42 rail
44 lift
101 structure for an offshore plant
104 structure body
104a upper end surface of structure body
106 tank
108 pump
110 pipe
111 pump opening
112 equipment module
112a underfloor surface
A height space
B floor height
Q draw-out area

1. A structure for an offshore plant, having a plurality of module portions mounted on a structure body in which a storage tank for storing liquefied natural gas is installed, wherein
a pump opening serving as an inlet/outlet of a pump for pumping up the liquefied natural gas from the storage tank is formed in the structure body; and
the pump opening is disposed between the module portions adjacent to each other.

2. The structure for an offshore plant according to claim 1, wherein the module portions comprise equipment module portions on which equipment is mounted and pipe module portions on which pipes are mounted.

3. The structure for an offshore plant according to claim 2, wherein the pump opening is disposed between the equipment module portions adjacent to each other.

4. The structure for an offshore plant according to claim 2, wherein the pump opening is disposed between the equipment module portion and the pipe module portion adjacent to each other.

5. The structure for an offshore plant according to claim 1, comprising a pipe for connecting the module portions,
wherein the pipe is disposed outside a draw-out area which is formed above the pump opening and used for drawing out the pump.

6. A structure for an offshore plant, having a plurality of module portions mounted on a structure body in which a storage tank for storing liquefied natural gas is installed, wherein
a pump opening serving as an inlet/outlet of a pump for pumping up the liquefied natural gas from the storage tank is formed in the structure body;
an upper end portion of the pump opening is located lower than an upper end surface of the structure body; and
the pump opening is located directly below the module portion.

7. The structure for an offshore plant according to claim 6, wherein the pump opening is formed in a recess formed by making the upper end surface recessed in the structure body.

8. The structure for an offshore plant according to claim 1, wherein a gravity based structure (GBS) or floating liquefied natural gas (FLNG) is used as a base portion.

9. The structure for an offshore plant according to claim 6, wherein a gravity based structure (GBS) or floating liquefied natural gas (FLNG) is used as a base portion.
